(19) United States
(12) Patent Application Publication
(10) Pub. No.: US 2025/0357479 A1
(43) Pub. Date: Nov. 20, 2025

(54) ALKALI METAL-CONTAINING OXIDE, POSITIVE ELECTRODE ACTIVE SUBSTANCE, ELECTRODE, AND BATTERY

(71) Applicants: SUMITOMO CHEMICAL COMPANY, LIMITED, Chuo-ku, Tokyo (JP); Kyoto University, Kyoto-shi, Kyoto (JP)

(72) Inventors: Tsutomu YAMABAYASHI, Niihama-shi, Ehime (JP); Hiroshi KAGEYAMA, Kyoto-shi, Kyoto (JP)

(21) Appl. No.: 18/869,554

(22) PCT Filed: May 19, 2023
(86) PCT No.: PCT/JP2023/018814

§ 371 Date: Nov. 26, 2024

(30) Foreign Application Priority Data
May 30, 2022 (JP) 2022-088008
Nov. 4, 2022 (JP) 2022-177539

(51) Int. Cl. H01M 4/505; C01G 45/1235; C01G 45/1242; H01M 4/02

(52) U.S. Cl. CPC H01M 4/505; C01G 45/1235; C01G 45/1242; C01P 2002/02; C01P 2002/32; C01P 2002/50; C01P 2002/72; C01P 2004/04; C01P 2006/40; H01M 2004/021

(57) ABSTRACT

An alkali metal-containing oxide of the present disclosure has a spinel structure and a composition represented by the following formula (1). In an X-ray diffraction chart measured at 25° C. using a CuKα ray, a peak having a half width of 0.5° to 5° is observed within a range of 40° to 45°.

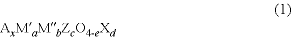

(In the formula (1), 1.1<x≤2.8, 0.8≤a<1.9, 0.05<b≤0.6, 1.0≤a+b<2.0, 0≤c<0.2, 0≤d<1.0, 0≤e<1.0,
A is an alkali metal element, M′ is at least one element from Ti, Cr, Mn, Fe, Co, Ni and Cu, M″ is at least one from Si, P, S, Ge and V, Z is an element of Group II to Group XVI except oxygen, M′ and M″, and X is a halogen element.)

### TECHNICAL FIELD

The present disclosure relates to an alkali metal-containing oxide, a positive electrode active substance, an electrode, and a battery.

### BACKGROUND ART

Secondary batteries performing charging and discharging by migrating alkali metal ions between the positive electrode and the negative electrode are known. Among such secondary batteries, lithium ion secondary batteries are typical, have been already put into practical use as small power supplies for mobile phones or laptops, and furthermore, can be used as large power supplies such as automotive power supplies for electric vehicles or hybrid vehicles or power supplies for distributed energy storage, and the demand thereof is increasing.

As positive electrode active substances for the above secondary batteries, alkali metal-containing oxides having a spinel-type crystal structure are known. In such alkali metal-containing oxides, for example, as in LiMn₂O₄, 32 oxide ions are present in one unit lattice, alkali metal ions occupy eight tetrahedral sites, and transition metal ions occupy 16 octahedral sites. In addition, alkali metal-containing oxides having a composition in which alkali metals are in excess such that the composition ratio of alkali metal ions per four oxygens is larger than one and the composition ratio of transition metal elements per four oxygens is smaller than two are also known (Patent Literature 1 to 6).

### Citation List

### Patent Literature

[Patent Literature 1] Japanese Unexamined Patent Application Publication No. H07-122299
[Patent Literature 2] Japanese Translation of PCT Application No. 2000-500280
[Patent Literature 3] Japanese Unexamined Patent Application Publication No. 2000-063123
[Patent Literature 4] Chinese Unexamined Patent Application Publication No. 102163716
[Patent Literature 5] Chinese Unexamined Patent Application Publication No. 103594700
[Patent Literature 6] Japanese Translation of PCT Application No. 2014-525667

### SUMMARY OF INVENTION

### Technical Problem

Here, spinel-type alkali metal-containing oxides had a room for improvement regarding the charge/discharge capacities.

The present disclosure has been made in consideration of the above circumstance, and an objective of the present disclosure is to provide an alkali metal-containing oxide having an excellent charge/discharge capacity, and an electrode and a battery containing such an alkali metal oxide.

### Solution to Problem

An alkali metal-containing oxide of the present disclosure has a spinel structure and has a composition represented by the following formula (1), and in an X-ray diffraction chart measured regarding the alkali metal-containing oxide at 25° C. using a CuKα ray, a peak having a half width of 0.5° to 5° at 2θ is observed within a range of 40° to 45° at 2θ.

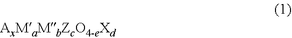

(In the formula (1), 1.1<x≤2.8, 0.8≤a≤1.9, 0.05<b≤0.6, 1.0≤a+b<2.0, 0≤c<0.2, 0≤d<1.0, 0≤e<1.0,
A is an alkali metal element,
M′ is at least one element selected from the group consisting of Ti, Cr, Mn, Fe, Co, Ni and Cu,
M″ is at least one selected from the group consisting of Si, P, S, Ge and V,
Z is an element of Group II to Group XVI in a periodic table except oxygen, M′ and M″, and
X is a halogen element.)

In the alkali metal-containing oxide, in a case where an electrochemical cell including an electrode containing the alkali metal-containing oxide, a lithium-metal auxiliary electrode and an electrolytic solution containing a lithium salt disposed between the electrode and the auxiliary electrode is produced, a battery is charged up to 4.8 V based on Li/Li⁺, and discharging is then performed to 1.5 V, x in the formula (1) may be within a range of 2.2 to 2.8.

In the formula (1), A may include Li.

In the formula (1), M″ may include V.

In the formula (1), 1.1<x≤2.0 may be satisfied.

An electrode of the present disclosure contains the alkali metal-containing oxide.

A non-aqueous secondary battery of the present disclosure includes the electrode as a positive electrode and a negative electrode containing lithium.

### Advantageous Effects of Invention

According to the present disclosure, it is possible to provide an alkali metal-containing oxide being excellent in terms of charge/discharge capacity and coulombic efficiency and an electrode and a battery containing such an alkali metal oxide.

### BRIEF DESCRIPTION OF DRAWINGS

FIG. 1 is an X-ray diffraction chart of lithium-containing oxides of Examples 1 to 4.

FIG. 2 is an X-ray diffraction chart of lithium-containing oxides of Examples 5 to 8.

FIG. 3 is an X-ray diffraction chart of lithium-containing oxides of Examples 9 and 10 and Comparative Examples 1 to 3.

FIG. 4 is a graph showing initial charge/discharge curves of Comparative Example 1 and Examples 1 and 3 to 6.

FIG. 5 is a graph showing initial charge/discharge curves of Comparative Example 1 and Examples 2, 7 and 8.

FIG. 6 is a graph showing initial charge/discharge curves of Comparative Example 1 and Examples 9 and 10.

FIG. 7 is a graph showing initial charge/discharge curves of Comparative Examples 1 to 3.

FIG. 8 is a graph in which, regarding the initial charge/discharge curves of Example 4 and Comparative Example 2, a composition ratio x of lithium when the amount of oxygen in the composition of the alkali metal-containing oxide being a positive electrode active substance is set to four (that is, x in a compositional formula LiₓMn_{1.4}V_{0.3}O₄) is indicated as an abscissa and a battery voltage is indicated as an ordinate.

FIG. 9 is a view showing an electron diffraction image of a sample of Example 5.

FIG. 10 is a view showing dark field observation images of the sample of Example 5 with a transmission electron microscope.

### DESCRIPTION OF EMBODIMENTS

An alkali metal-containing oxide of the present embodiment has a spinel structure and has a composition represented by the following formula (1), and in an X-ray diffraction chart measured regarding an alkali metal oxide at 25° C. using a CuKα ray, a peak having a half width of 0.5° to 5° at 2θ is observed within a range of 40° to 45° at 2θ.

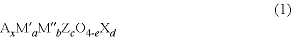

(In the formula (1), 1.1<x≤2.8, 0.8≤a≤1.9, 0.05<b≤0.6, 1.0≤a+b<2.0, 0≤c<0.2, 0≤d<1.0, 0≤e<1.0,
A is an alkali metal element,
M′ is at least one element selected from the group consisting of Ti, Cr, Mn, Fe, Co, Ni and Cu,
M″ is at least one selected from the group consisting of Si, P, S, Ge and V,
Z is an element of Group II to Group XVI in a periodic table except oxygen, M′ and M″, and
X is a halogen element.)

A is not particularly limited as long as A is an alkali metal element and may include at least one selected from the group consisting of Li, Na, K, Rb and Cs, may include at least one selected from the group consisting of Li, Na and K, may include at least one of Li and Na or may include Li.

In the total amount of alkali metals that are contained in the alkali metal-containing oxide of the present embodiment, the content of one alkali metal may be 90 mol % or more, may be 95 mol % or more, may be 98 mol % or more, may be 99 mol % or more or may be 99.9 mol % or more or substantially only one alkali metal may be contained (that is, the content of alkali metals except the one alkali metal is substantially 0 mol %). The one alkali metal may be Li, Na or K, may be Li or Na or may be Li. In a case where the alkali metal-containing oxide mainly contains Li (for example, a case where the content of one alkali metal is 80 mol % or more or the like in the total amount of alkali metals that are contained in the alkali metal-containing oxide), in the X-ray diffraction chart, there is a tendency that a peak having a half width of 0.5° to 5° at 2θ is observed within a range of 43° to 45° at 2θ.

In the formula (1), x may be more than 1.1 and 2 or less, may be 1.13 to 2.75, may be 1.15 to 2.7, may be 1.2 to 2.6 or may be 1.25 to 2.5. In addition, x may be 1.13 to 2.1, may be 1.15 to 2.0, may be 1.2 to 1.95 or may be 1.25 to 1.9.

M′ may include at least one element selected from the group consisting of Ti, Cr, Mn, Fe, Co, Ni and Cu, may include at least one of Cr, Mn and Ni, may include at least one of Mn and Ni or may include Mn.

M″ may include at least one element selected from the group consisting of Si, P, S, Ge and V, may include at least one of P and V or may include V. M″ may include V or may include V and P.

a may be 0.9 to 1.9, may be 1.0 to 1.85, may be 1.0 to 1.7 or may be 1.0 to 1.6. b may be 0.06 to 0.58, may be 0.08 to 0.55 or may be 0.1 to 0.5. b may be 0.15 to 0.55 or may be 0.2 to 0.5.

a+b may be 1.2 to 1.95 or may be 1.5 to 1.93.

Z is an element of Group II to Group XVI in the periodic table except oxygen, M′ and M″, and examples thereof include Al, Mg, Ca, Zr, Nb, Mo, Ru, W, Sn and the like.

c may be 0.1 or less, may be 0.05 or less, may be 0.01 or less or may be substantially 0.

X may include at least one element selected from the group consisting of F, Cl, Br and I, may include at least one of F and Cl or may include F.

d may be 0.8 or less, may be 0.6 or less, may be 0.4 or less, may be 0.2 or less, may be 0.05 or less or may be 0.01 or less. d may be 0.001 or more or may be 0. In addition, d may be 0.001 to 0.8, may be 0.001 to 0.6 or may be 0.001 to 0.2. e may be 0.8 or less, may be 0.6 or less, may be 0.4 or less, may be 0.2 or less, may be 0.05 or less, may be 0.01 or less or may be 0. e may be 0.001 or more. In addition, e may be 0.001 to 0.8, may be 0.001 to 0.6 or may be 0.001 to 0.2.

The half width of the X-ray diffraction peak that is observed within the above range of 40° to 45° may be 0.7° to 4.5°, may be 0.9° to 4.0°, may be 1.0° to 3.8° or may be 1.28° to 3.5°. The half width of the X-ray diffraction peak that is observed within the above range of 43° to 45° may be 0.7° to 4.5°, may be 0.9° to 4.0°, may be 1.0° to 3.8° or may be 1.28° to 3.5°.

For the alkali metal-containing oxide of the present embodiment, in the above X-ray diffraction chart, a peak having a half width of 0.5° to 8° at 2θ may be observed within a range of 63° to 66° at 2θ. The half width of the peak may be 1.0° to 7.5°.

The alkali metal-containing oxide of the present embodiment may have a crystal phase and also has an amorphous phase. The crystal phase may have been dispersed in the amorphous phase. When an amorphous phase is present, there is a tendency that the diffusion of lithium ions in a material improves. The alkali metal-containing oxide of the present embodiment may have a crystal phase having an average particle diameter of 1 to 30 nm in terms of equivalent circle diameter (crystallite). The average particle diameter of the crystal phase (crystallite) may be 1 to 20 nm or may be 1 to 15 nm in terms of equivalent circle diameter. Here, the amorphous phase can be confirmed by observation with a transmission electron microscope (TEM).

The alkali metal-containing oxide of the present embodiment may be an alkali metal-containing oxide containing 8 to 15 mass % of Li, 32 to 57 mass % of M′, which is at least one element selected from the group consisting of Ti, Cr, Mn, Fe, Co, Ni and Cu, and 3 to 30 mass % of M″, which is at least one selected element from the group consisting of Si, P, S, Ge and V, in which, in an X-ray diffraction chart measured at 25° C. using a CuKα ray, a peak pattern belonging to the spinel structure is observed, and a peak having a half width of 0.5° to 5° is observed within a range of 40° to 45° at 20. The alkali metal-containing oxide may contain an element of Group II to Group XVI in a periodic table except oxygen, M′ and M″. Specific examples of the element Z include those exemplified as Z in the formula (1). The content of Z may be 20 mass % or less, may be 10 mass % or less, may be 5 mass % or less, may be 1 mass % or less or may be substantially 0 mass % relative to the total amount of the alkali metal-containing oxide. In addition, the alkali metal-containing oxide may also contain a halogen element, and examples of the halogen element include those exemplified as X in the formula (1). The content of the halogen element may be 20 mass % or less, may be 10 mass % or less, may be 5 mass % or less, may be 1 mass % or less or may be substantially 0 mass % relative to the total amount of the alkali metal-containing oxide. The alkali metal-containing oxide may be a single phase or may include a layer, and a peak except the peak belonging to the spinel structure may also be observed when an X-ray diffraction test has been performed. The alkali metal-containing oxide may have a crystal phase (crystallite) and also may have an amorphous phase.

A method for producing the alkali metal-containing oxide is not particularly limited, and examples thereof include a method in which a spinel type oxide containing Li and M′ and an alkali metal salt containing M″ are mechanochemically mixed together with a ball mill. Examples of the spinel type oxide include, in the case of lithium-containing oxides, LiMnTiO₄, LiCrMnO₄, LiMn₂O₄, LiFeMnO₄, LiCoMnO₄, LiNi_{0.5}Mn_{1.5}O₄ and LiCu_{0.5}Mn_{1.5}O₄. Examples of the lithium salt include Li₃VO₄, Li₄SiO₄, Li₂SiO₃, Li₃P_{0.5}V_{0.5}O₄, Li₂GeO₄, Li₂O₄ and the like. In addition, as a raw material, an alkali metal oxide such as Li₂O or an oxide of M′ or M″ such as V₂O₅, GeO₂ or SiO₂ can also be used as the raw material. The raw material is not limited to the above materials, and at least one of Li, M′ and M″ and a compound containing oxygen may be blended together so as to produce a target composition. Ball mill conditions are not particularly limited, the rotation speed may be 100 to 700 rpm, and the mixing time may be 0.5 to 72 hours or may be 10 to 60 hours. In addition, the mixing time may be 20 to 72 hours or may be 30 to 60 hours. In addition, in a case where X is introduced in to the formula (1), an alkali metal salt or the like of X can also be used as the raw material.

The alkali metal-containing oxide of the present embodiment can be used as a material of batteries (lithium ion batteries, sodium ion batteries and the like). That is, a battery of the present embodiment contains the alkali metal-containing oxide. The battery may be a primary battery or may be a secondary battery. In addition, the battery may be a non-aqueous battery. In the battery, the alkali metal-containing oxide may be contained in an electrode.

The battery of the present embodiment has a positive electrode, a negative electrode and an electrolyte disposed between the positive electrode and the negative electrode.

A positive electrode of the present embodiment contains a current collector and a positive electrode mixture supported on the current collector. The positive electrode mixture may form a positive electrode mixture layer on the current collector.

The positive electrode mixture contains the alkali metal-containing oxide and may contain a conductive material (conductive auxiliary agent), a binder or the like as necessary. That is, the alkali metal-containing oxide may be contained in a positive electrode active substance.

Examples of the conductive material include carbon materials such as natural graphite, artificial graphite, cokes, carbon black, acetylene black and the like. Examples of the binder include thermoplastic resins, and specific examples thereof include fluororesins such as polyvinylidene fluoride (hereinafter, also referred to as “PVDF”), polytetrafluoroethylene, tetrafluoroethylene-hexafluoropropylene-vinylidene fluoride-based copolymers, hexafluoropropylene-vinylidene fluoride-based copolymers, and tetrafluoroethylene-perfluorovinyl ether-based copolymers; polyolefin resins such as polyethylene and polypropylene; and the like. As the current collector, Al, Ni, stainless steel and the like can be used.

Examples of a method for supporting the positive electrode mixture on the current collector include a pressure molding method, a method in which an electrode mixture is made into a paste using an organic solvent or the like, and the paste is applied onto a current collector, dried and fixed by pressing or the like and the like. In the case of making the electrode mixture into a paste, for example, a slurry composed of the positive electrode active substance, a conductive material, a binder and an organic solvent is produced. Examples of the organic solvent include amine-based solvents such as N,N-dimethylaminopropylamine and diethyltriamine; ether-based solvents such as ethylene oxide and tetrahydrofuran; ketone-based solvents such as methyl ethyl ketone; ester-based solvents such as methyl acetate; aprotic polar solvents such as dimethylacetamide and N-methyl-2-pyrrolidone and the like. Examples of a method for applying the electrode mixture to the current collector include a slit die application method, a screen application method, a curtain application method, a knife application method, a gravure application method, an electrostatic spray method and the like.

The negative electrode of the battery is not particularly limited and may be an electrode containing a negative electrode active substance and containing a conductive auxiliary agent, a binding agent or the like as necessary. Examples of a negative electrode active substance of a lithium ion battery include pure elements such as Li, Si, P, Sn, Si—Mn, Si—Co, Si—Ni, In and Au, alloys or complexes containing the above elements, carbon materials such as graphite, substances containing lithium ions inserted between layers of the carbon material and the like. In the case of a negative electrode of a sodium ion battery, substances obtained by replacing Li in the substances exemplified as a negative electrode material of the lithium ion battery with Na can be used as a negative electrode material.

The electrolyte of the battery is not particularly limited, and an electrolytic solution obtained by dissolving an alkali metal salt in an organic solvent can be used. In addition, the electrolyte may be a solid electrolyte. Examples of the alkali metal salt include iodide salts, tetrafluoroborate salts, hexafluorophosphate salts, bis(fluorosulfonyl)imide salts, bis(trifluoromethylsulfonyl)imide salts and the like.

The organic solvent that is contained in the electrolytic solution is not particularly limited, and examples thereof include non-aqueous solvents, for example, cyclic carbonate esters such as ethylene carbonate (EC) or propylene carbonate (PC), linear carbonate esters such as dimethyl carbonate (DMC), diethyl carbonate (DEC), or ethyl methyl carbonate (EMC), sultones and the like. The solvent may be singly used or two or more solvents may be used in combination.

The alkali metal-containing oxide of the present embodiment has an excellent storage capability of alkali metal ions. Therefore, in the alkali metal-containing oxide of the present embodiment, in a case where an electrochemical cell including an electrode containing the alkali metal-containing oxide, a lithium-metal auxiliary electrode and an electrolytic solution containing a lithium salt disposed between the electrode and the auxiliary electrode is produced, a battery is charged up to 4.8 V based on Li/Li⁺ (initial charging), and discharging is then performed to 1.5 V, x in the formula (1) may be within a range of 2.2 to 2.8. x after the initial charging and discharging may be 2.25 to 2.7, may be 2.3 to 2.6 or may be 2.35 to 2.55.

A positive electrode active substance of the present embodiment may be a positive electrode active substance containing a composite oxide containing an alkali metal element, the element M′ and the element M″, containing 8 to 27 mass % of the alkali metal element, 26 to 57 mass % of the element M′, which is at least one selected from the group consisting of Ti, Cr, Mn, Fe, Co, Ni and Cu, and containing 2 to 30 mass % of the element M″, which is at least one selected from the group consisting of Si, P, S, Ge and V, in which, in an X-ray diffraction chart measured regarding the positive electrode active substance at 25° C. using a CuKα ray, a peak pattern belonging to the spinel structure derived from the composite oxide is observed, and a peak having a half width of 0.5° to 5° is observed within a range of 40° to 45° at 2θ. The composite oxide that is contained in the positive electrode active substance may contain the above alkali metal-containing oxide. The positive electrode active substance may have a crystal phase (crystallite) of the composite oxide and an amorphous phase.

The present disclosure includes the following substantial embodiments.

### Embodiment 1

An alkali metal-containing oxide having a spinel structure and having a composition represented by the following formula (1),
in which, in an X-ray diffraction chart measured regarding the alkali metal-containing oxide at 25° C. using a CuKα ray, a peak having a half width of 0.5° to 5° at 2θ is observed within a range of 40° to 45° at 2θ.

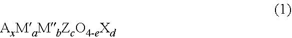

(In the formula (1), 1.1<x≤2.8, 0.8≤a<1.9, 0.05<b≤0.6, 1.0≤a+b<2.0, 0≤c<0.2, 0≤d<1.0, 0≤e<1.0,
A is an alkali metal element,
M′ is at least one element selected from the group consisting of Ti, Cr, Mn, Fe, Co, Ni and Cu,
M″ is at least one selected from the group consisting of Si, P, S, Ge and V,
Z is an element of Group II to Group XVI in a periodic table except oxygen, M′ and M″, and
X is a halogen element.)

### Embodiment 2

The alkali metal-containing oxide of Embodiment 1, in which, in a case where an electrochemical cell including an electrode containing the alkali metal-containing oxide, a lithium-metal auxiliary electrode and an electrolytic solution containing a lithium salt disposed between the electrode and the auxiliary electrode is produced, the electrochemical cell is charged up to 4.8 V based on Li/Li⁺, and discharging is then performed to 1.5 V, x in the formula (1) may be within a range of 2.2 to 2.8.

### Embodiment 3

The alkali metal-containing oxide of Embodiment 1 or 2, in which, in the formula (1), A contains Li.

### Embodiment 4

The alkali metal-containing oxide of any one of Embodiments 1 to 3, in which, in the formula (1), M″ contains V.

### Embodiment 5

The alkali metal-containing oxide of any one of Embodiments 1 to 4, in which, in the formula (1), 1.1<x≤2.0 is satisfied.

### Embodiment 6

The alkali metal-containing oxide of any one of Embodiments 1 to 5, having an amorphous phase.

### Embodiment 7

An electrode containing the alkali metal-containing oxide of any one of Embodiments 1 to 6.

### Embodiment 8

A battery including the electrode described in Embodiment 7 as a positive electrode and a negative electrode containing lithium.

### Embodiment 9

A positive electrode active substance containing a composite oxide containing an alkali metal element, an element M′ and an element M″, in which 8 to 15 mass % of the alkali metal element is contained, 32 to 57 mass % of the element M′, which is at least one selected from the group consisting of Ti, Cr, Mn, Fe, Co, Ni and Cu, is contained, and 3 to 30 mass % of the element M″, which is at least one selected from the group consisting of Si, P, S, Ge and V, is contained, in an X-ray diffraction chart measured regarding the positive electrode active substance at 25° C. using a CuKα ray, a peak pattern belonging to the spinel structure derived from the composite oxide is observed, and a peak having a half width of 0.5° to 5° is observed within a range of 40° to 45° at 2θ.

### Embodiment 10

The positive electrode active substance of Embodiment 9, having an amorphous phase.

### Embodiment 11

An alkali metal-containing oxide having a crystal phase having a spinel structure and an amorphous phase and having a composition represented by the following formula (1),
in which, in an X-ray diffraction chart measured regarding the alkali metal-containing oxide at 25° C. using a CuKα ray, a peak having a half width of 0.5° to 5° at 2θ is observed within a range of 40° to 45° at 2θ.

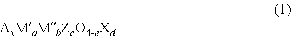

(In the formula (1), 1.1<x≤2.8, 0.8≤a<1.9, 0.05<b≤0.6, 1.0≤a+b<2.0, 0≤c<0.2, 0≤d<1.0, 0≤e<1.0,
A is an alkali metal element,
M′ is at least one element selected from the group consisting of Ti, Cr, Mn, Fe, Co, Ni and Cu,
M″ is at least one selected from the group consisting of Si, P, S, Ge and V,
Z is an element of Group II to Group XVI in a periodic table except oxygen, M′ and M″, and
X is a halogen element.)

### Examples

### Example 1

A LiMn₂O₄ powder and a Li₃VO₄ powder, which were raw materials, were produced as described below.

First, lithium carbonate (manufactured by Fujifilm Wako Pure Chemical Corporation) and manganese (IV) oxide (manufactured by Fujifilm Wako Pure Chemical Corporation) were mixed together in a mole ratio of 1:4 and fired at 800° C. in the air for 18 hours to obtain the LiMn₂O₄ powder. In addition, lithium carbonate (manufactured by Fujifilm Wako Pure Chemical Corporation) and vanadium (V) oxide (manufactured by Fujifilm Wako Pure Chemical Corporation) were mixed together in a mole ratio of 3:1 and fired at 650° C. in the air for 12 hours to obtain the Li₃VO₄ powder.

The obtained LiMn₂O₄ powder and Li₃VO₄ powder were mixed together in a mole ratio of 0.9:0.1 and introduced into a zirconia ball mill container so that the mass ratio of zirconia balls having a diameter of 4 mm and the powder mixture reached 65:1. The ball mill container was introduced in a planetary ball mill device (manufactured by Retsch GmbH, PM200), and ball milling was performed at a rotation speed of 500 rpm for 48 hours, thereby obtaining a lithium-containing oxide.

### Examples 2 to 6 and Comparative Example 3

Lithium-containing oxides were produced in the same manner as in Example 1 except that the blending amounts and/or mixing time of the LiMn₂O₄ powder and the Li₃VO₄ powder, which were the raw materials, were changed as shown in Table 1.

### Example 7

A lithium-containing oxide was produced in the same manner as in Example 1 except that a LiNi_{0.5}Mn_{1.5}O₄ powder and a Li₃VO₄ powder were used in a mole ratio of 0.8:0.2 as raw materials.

The LiNi_{0.5}Mn_{1.5}O₄ powder was obtained by weighing lithium carbonate (manufactured by Fujifilm Wako Pure Chemical Corporation), nickel (II) oxide (manufactured by Fujifilm Wako Pure Chemical Corporation) and manganese (IV) oxide (manufactured by Fujifilm Wako Pure Chemical Corporation) so that the mole ratio reached 1:1:3, mixing these together with ethanol and zirconia balls having a diameter of 8 mm with a wet-type ball mill and firing the powder mixture after filtration and drying in the atmosphere at 600° C. for 15 hours.

### Example 8

A lithium-containing oxide was produced in the same manner as in Example 1 except that a LiMn₂O₄ powder and a Li₃V_{0.5}P_{0.5}O₄ powder were used in a mole ratio of 0.8:0.2 as raw materials.

The Li₃V_{0.5}P_{0.5}O₄ powder was obtained by mixing lithium carbonate (manufactured by Fujifilm Wako Pure Chemical Corporation), diammonium hydrogenphosphate (manufactured by Fujifilm Wako Pure Chemical Corporation) and vanadium (V) oxide (manufactured by Fujifilm Wako Pure Chemical Corporation) in a mole ratio of 6:2:1 and firing the powder mixture in the atmosphere at 800° C. for 10 hours.

### Examples 9 and 10

Lithium-containing oxides were produced in the same manner as in Example 1 except that a LiCrMnO₄ powder and a Li₃VO₄ powder were used as raw materials in a mole ratio shown in Table 1.

LiCrMnO₄ was obtained by mixing lithium carbonate (manufactured by Fujifilm Wako Pure Chemical Corporation), chromium (III) oxide (manufactured by Fujifilm Wako Pure Chemical Corporation) and manganese (III) oxide (manufactured by Fujifilm Wako Pure Chemical Corporation) in a mole ratio of 1:1:1, firing the powder mixture in the atmosphere at 800° C. for 6 hours and further firing the powder mixture in the atmosphere at 900° C. for 12 hours.

### Comparative Example 1

A lithium-containing oxide was produced in the same manner as in Example 1 except that ball milling was performed only on a LiMn₂O₄ powder.

### Comparative Example 2

The LiMn₂O₄ powder, which was the raw material produced in Example 1, was used as it was.

### X-Ray Diffraction

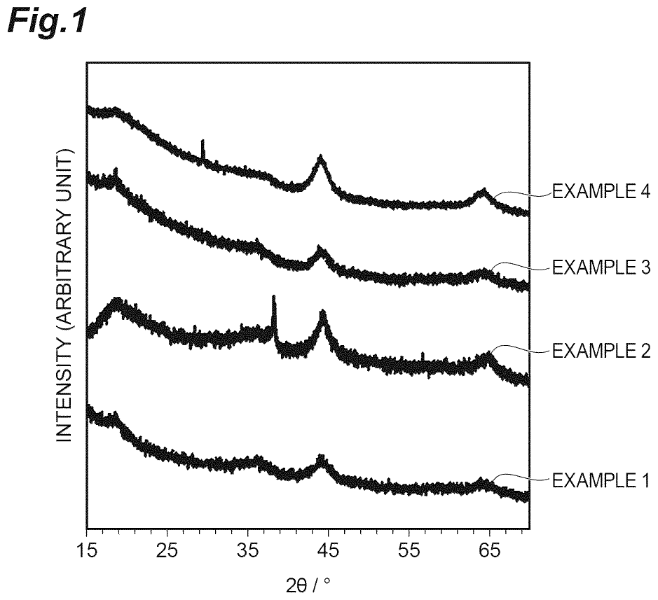

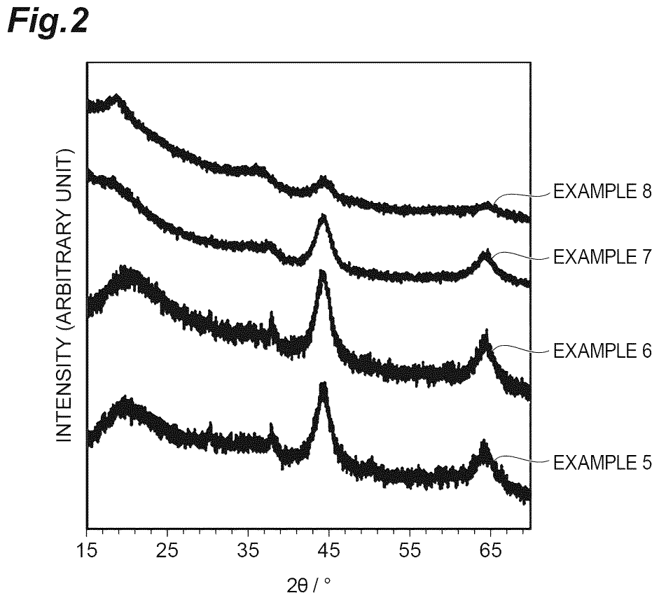

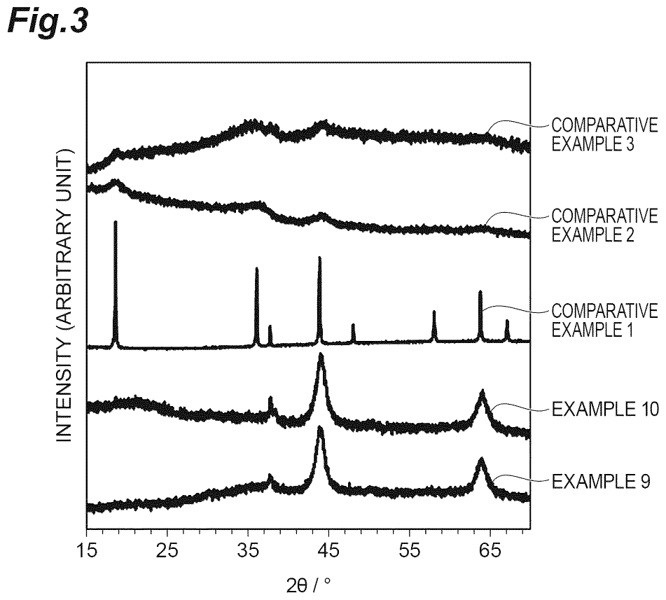

Powder X-ray diffraction measurement was performed on each lithium-containing oxide of the examples and the comparative examples using a powder X-ray diffraction measuring instrument (manufactured by Rigaku Corporation, Ultima IV). The measurement was performed at room temperature (25° C.). The lithium ion-containing oxide was loaded into a hollow on a glass plate, the glass plate on which the sample was placed was sealed in an airtight sample stage having a beryllium window to avoid air and humidity, and the measurement was performed while the sample remained unexposed to the atmosphere. The measurement was performed using a Cukα-ray source at an output of 40 kV and 40 mA within a diffraction angle 2θ range of 10° to 90° at 0.02° steps and a rate of 2° /minute. The peak positions and half widths of peaks observed at 40° to 45° (2θ) are shown in Tables 1 and 2. FIG. 1 is the X-ray diffraction chart of the lithium-containing oxides of Examples 1 to 4. FIG. 2 is the X-ray diffraction chart of the lithium-containing oxides of Examples 5 to 8. FIG. 3 is the X-ray diffraction chart of the lithium-containing oxides of Examples 9 and 10 and Comparative Examples 1 to 3. As is clear from FIGS. 1 to 3, the lithium-containing oxides of Examples 1 to 10 exhibited the same diffraction pattern as that in Comparative Example 2.

TABLE 1

| | | | | | Ball | | |
|---|---|---|---|---|---|---|---|
| | | | | | milling | Peak | Half |
| | | | | | mixing | position | width |
| | Composition (mole ratio) | | | | time | 2θ (°) | (°) |
| Example 1 | 0.9 | LiMn₂O₄ | 0.1 | Li₃VO₄ | 48 | 44.2 | 3.21 |
| Example 2 | 0.8 | LiMn₂O₄ | 0.2 | Li₃VO₄ | 12 | 44.4 | 1.66 |
| Example 3 | 0.8 | LiMn₂O₄ | 0.2 | Li₃VO₄ | 48 | 44.2 | 2.10 |
| Example 4 | 0.7 | LiMn₂O₄ | 0.3 | Li₃VO₄ | 48 | 44.0 | 2.22 |
| Example 5 | 0.6 | LiMn₂O₄ | 0.4 | Li₃VO₄ | 48 | 44.2 | 2.33 |
| Example 6 | 0.5 | LiMn₂O₄ | 0.4 | Li₃VO₄ | 48 | 44.2 | 1.92 |
| Example 7 | 0.8 | LiNi_{0.5}Mn_{1.5}O₄ | 0.2 | Li₃VO₄ | 48 | 44.2 | 2.32 |
| Example 8 | 0.8 | LiMn₂O₄ | 0.2 | Li₃V_{0.5}P_{0.5}O₄ | 48 | 44.4 | 2.34 |
| Example 9 | 0.8 | LiCrMnO₄ | 0.2 | Li₃VO₄ | 48 | 43.9 | 1.33 |
| Example 10 | 0.6 | LiCrMnO₄ | 0.4 | Li₃VO₄ | 48 | 44.1 | 1.32 |
| Comparative | 1 | LiMn₂O₄ | — | — | 48 | 44.1 | 2.07 |
| Example 1 | | | | | | | |
| Comparative | 1 | LiMn₂O₄ | — | — | 0 | 43.9 | 0.15 |
| Example 2 | | | | | | | |
| Comparative | 0.95 | LiMn₂O₄ | 0.05 | Li₃VO₄ | 48 | 44.1 | 2.69 |
| Example 3 | | | | | | | |

TABLE 2

| | Peak | Half |
|---|---|---|
| | position | width |
| | 2θ (°) | (°) |
| Example 1 | 64.3 | 4.0 |
| Example 2 | 64.5 | 2.70 |
| Example 3 | 63.8 | 4.48 |
| Example 4 | 64.2 | 3.62 |
| Example 5 | 64.1 | 3.19 |
| Example 6 | 64.2 | 2.54 |
| Example 7 | 64.3 | 2.76 |
| Example 8 | 64.5 | 7.0 |
| Example 9 | 63.8 | 4.7 |
| Example 10 | 63.9 | 1.67 |
| Comparative | 64.7 | 9.2 |
| Example 1 | | |
| Comparative | 63.8 | 0.16 |
| Example 2 | | |
| Comparative | Not | Not |
| Example 3 | observed | observed |

### Charge/Discharge Test

### (1) Production of Positive Electrode

The lithium-containing oxide of Examples 1 to 10 and Comparative Examples 1 and 3 (positive electrode active substance), acetylene black (trade name: HS-100, manufactured by Denka Company Limited.) as a conductive material and polytetrafluoroethylene (PTFE, model No.: 6-J, Chemours-Mitsui Fluoroproducts Co., Ltd.) as a binder were each weighed so as to prepare a composition of the positive electrode active substance/the conductive material/the binder =70/20/10 (mass ratio). First, the positive electrode active substance and the conductive material were sufficiently mixed together with an agate mortar, the binder was added thereto, and the components were further mixed together. Seven milligrams of a mixture was weighed and stretched out in a circle on the mortar. The stretched mixture was pressure-bonded to a 110 μm-thick aluminum mesh (100 meshes, manufactured by The Nilaco Corporation), which was a current collector, to obtain a positive electrode containing the positive electrode active substance.

Regarding Comparative Example 2, a paste-like positive electrode mixture was prepared by adding and kneading the lithium-containing oxide (positive electrode active substance), acetylene black (trade name: HS-100, manufactured by Denka Company Limited.) and a N-methyl-2-pyrrolidone (NMP) solution of PVDF (KF polymer, model No.: L #1120, manufactured by Kureha Corporation) as a binder in proportions in which a composition of the positive electrode active substance/the acetylene black/PVDF with a (mass ratio) of 85:10:5 was prepared. During the preparation of the positive electrode mixture, the viscosity of the paste was adjusted by adding NMP. The obtained positive electrode mixture was applied to a 40 μm-thick Al foil, which served as a current collector, dried in the atmosphere at 60° C. for one hour, then, dried in a vacuum at 150° C. for eight hours and blanked into a circle having a diameter of 14.5 mm, thereby obtaining a positive electrode.

### Production and Evaluation of Li Half Cell

A coin-type battery CR2032 type was assembled using the positive electrode, a polyethylene porous film (thickness: 16 μm) as a separator, a 1 M LiPF₆ solution (a solvent was a solvent mixture containing ethylene carbonate (EC), dimethyl carbonate (DMC) and ethyl methyl carbonate (EMC) in a volume ratio of 30:35:35) as a non-aqueous electrolytic solution and metallic lithium as an auxiliary electrode. The battery was assembled in a globe box in an argon atmosphere. Charge/discharge tests were performed using the produced coin-type batteries at 25° C. within a voltage range of 1.5 to 4.8 V for Examples 1 to 8 and Comparative Examples 1 to 3 and a voltage range of 1.5 to 4.5 V for Example 9 and Example 10 under the following conditions. The measurement results of the initial discharge energy densities and the energy efficiencies are shown in Table 3.

Charge/discharge conditions: Constant-current constant-voltage charging (CC-CV) charging was performed at 30 mA/g and a cut-off condition of 6 mA/g.

Discharge condition: Constant-current (CC) discharging was performed at 30 mA/g.

TABLE 3

| | | | Initial | Initial | |
|---|---|---|---|---|---|
| | | Ball milling | charge | discharge | Coulombic |
| | Composition | mixing time | capacity | capacity | efficiency |
| | (mole ratio) | (hours) | (mAh/g) | (mAh/g) | (%) |
| Example 1 | Li_{1.2}Mn_{1.8}V_{0.1}O₄ | 48 | 139 | 314 | 226 |
| Example 2 | Li_{1.4}Mn_{1.6}V_{0.2}O₄ | 12 | 179 | 332 | 186 |
| Example 3 | Li_{1.4}Mn_{1.6}V_{0.2}O₄ | 48 | 179 | 350 | 196 |
| Example 4 | Li_{1.6}Mn_{1.4}V_{0.3}O₄ | 48 | 221 | 357 | 161 |
| Example 5 | Li_{1.8}Mn_{1.2}V_{0.4}O₄ | 48 | 276 | 388 | 140 |
| Example 6 | Li_{2.0}Mn_{1.0}V_{0.5}O₄ | 48 | 307 | 343 | 112 |
| Example 7 | Li_{1.4}Mn_{0.4}V_{1.2}V_{0.2}O₄ | 48 | 179 | 323 | 180 |
| Example 8 | Li_{1.4}Mn_{1.6}V_{0.1}P_{0.1}O₄ | 48 | 192 | 334 | 175 |
| Example 9 | Li_{1.4}Cr_{0.8}Mn_{0.8} V_{0.2}O₄ | 48 | 196 | 317 | 162 |
| Example 10 | Li_{1.8}Cr_{0.6}Mn_{0.6}V_{0.4}O₄ | 48 | 239 | 353 | 148 |
| Comparative | LiMn₂O₄ | 48 | 83 | 245 | 295 |
| Example 1 | | | | | |
| Comparative | LiMn₂O₄ | 0 | 138 | 257 | 186 |
| Example 2 | | | | | |
| Comparative | Li_{1.1}Mn_{1.9}V_{0.05}O₄ | 48 | 77 | 236 | 306 |
| Example 3 | | | | | |

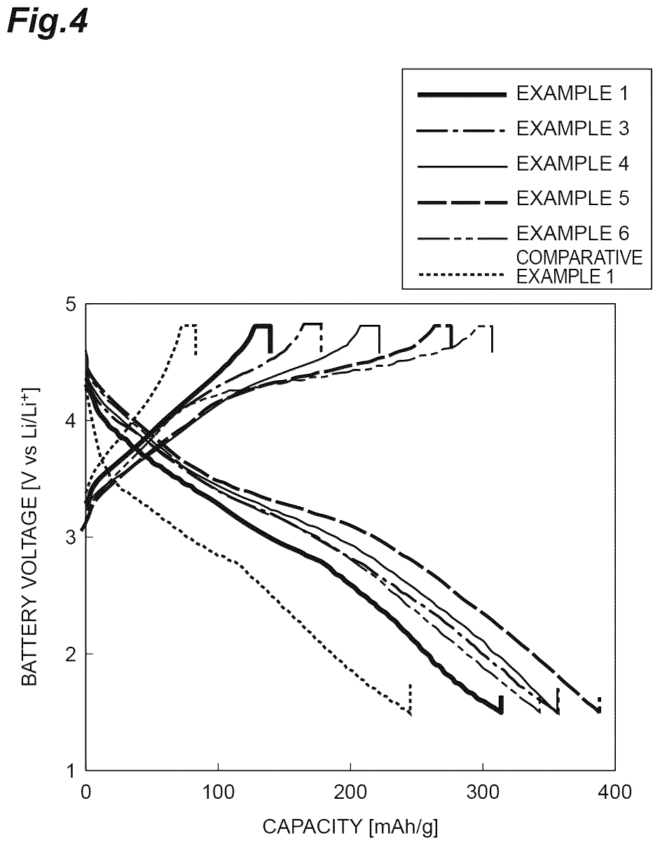

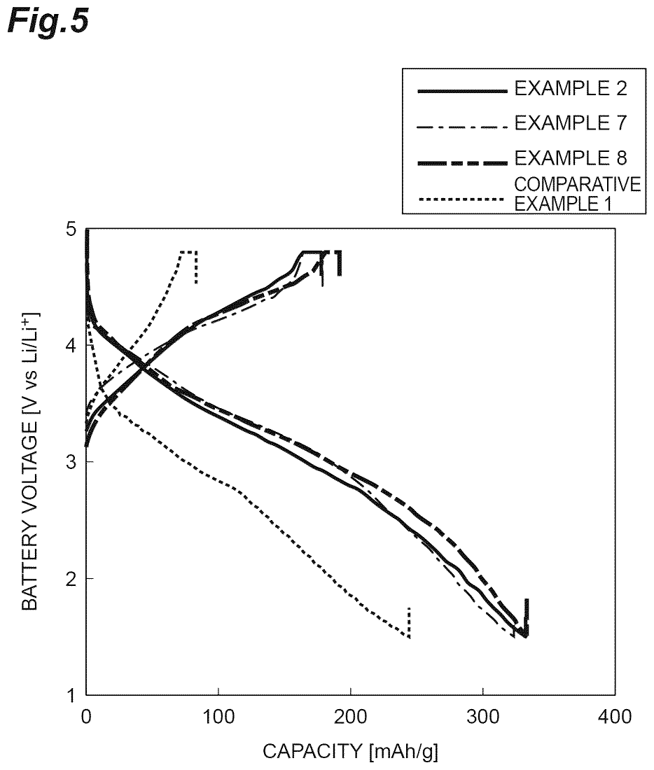

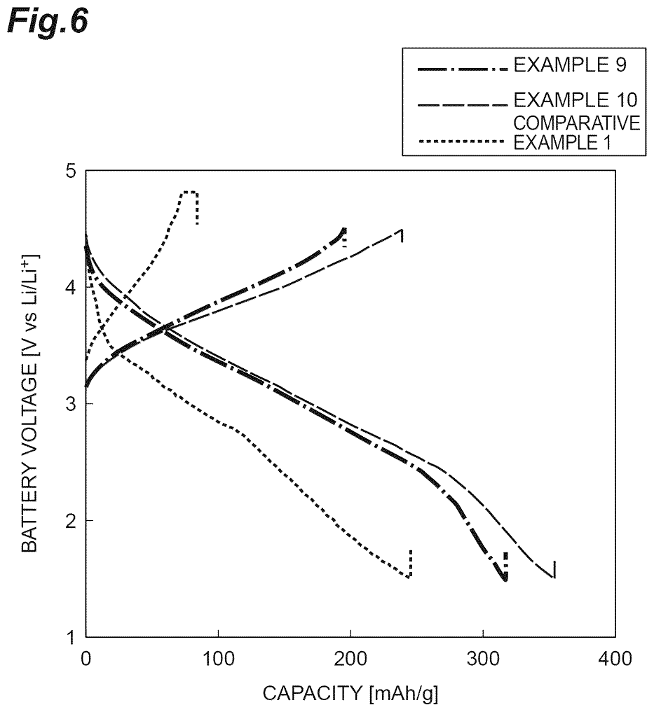

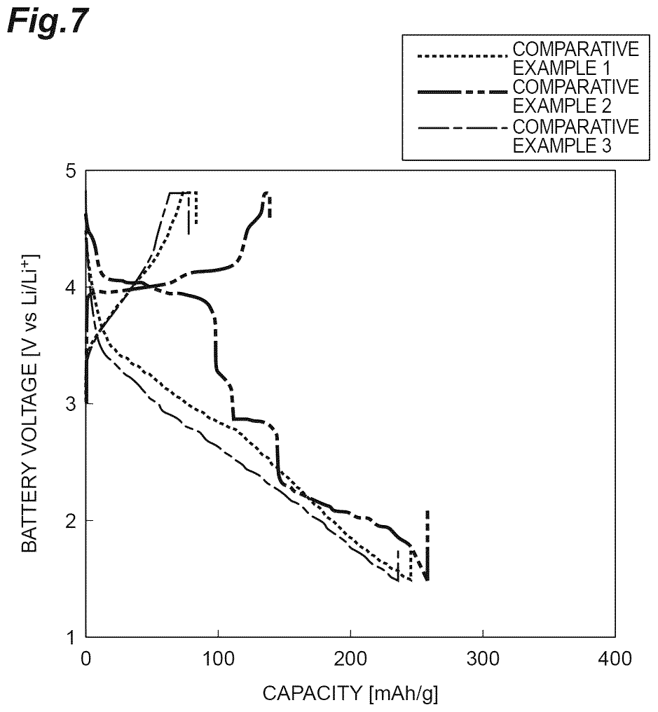

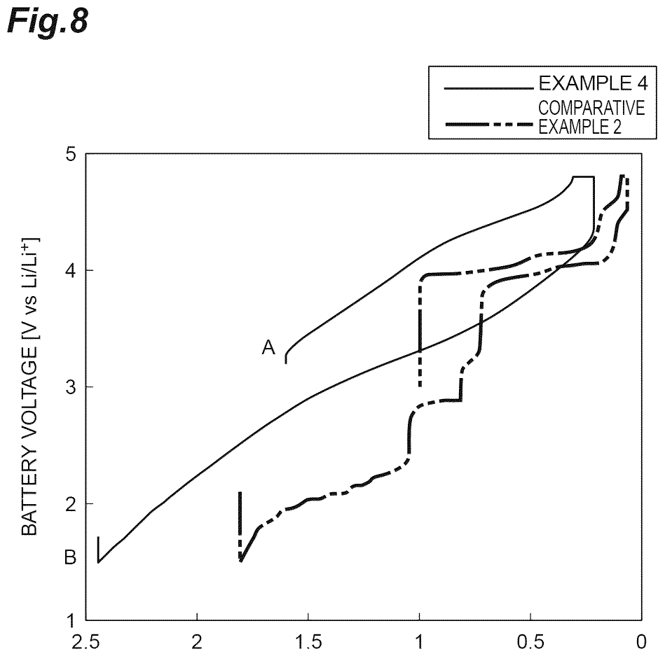

FIG. 4 is a graph showing the initial charge/discharge curves of Comparative Example 1 and Examples 1 and 3 to 6. FIG. 5 is a graph showing the initial charge/discharge curves of Comparative Example 1 and Examples 2, 7 and 8. FIG. 6 is a graph showing the initial charge/discharge curves of Comparative Example 1 and Examples 9 and 10. FIG. 7 is a graph showing the initial charge/discharge curves of Comparative Examples 1 to 3. In FIGS. 4 to 7, the abscissa indicates the capacity of the positive electrode active substance, and the ordinate indicates the battery voltage. FIG. 8 is a graph in which, regarding the initial charge/discharge curves of Example 4 and Comparative Example 2, the composition ratio x of lithium when the amount of oxygen in the composition of the alkali metal-containing oxide being the positive electrode active substance is set to four (that is, x in a compositional formula LiₓMn_{1.4}V_{0.3}O₄) is indicated as the abscissa and the battery voltage is indicated as the ordinate. A in FIG. 8 indicates a state before the initiation of charging, and the composition of the lithium-containing oxide that is contained in the positive electrode at this time is Li_{1.6}Mn_{1.4}V_{0.3}O₄. After that, when the above charge/discharge test is performed, and the migration amount of lithium ions is calculated from the current value, it is found that the composition of the lithium-containing oxide when B (at the time of the completion of discharging) in FIG. 8 is reached is Li_{2.45}Mn_{1.4}V_{0.3}O₄ and the lithium ion storage capacity is excellent.

### Observation With Transmission Electron Microscope

Observation was performed under the following measurement conditions.

Device: Analytical electron microscope ARM200F manufactured by JEOL Ltd.

Measurement condition: Accelerating voltage of 200 kV

Sample adjustment: Sample preparation was performed on the lithium-containing oxide of Example 5 by a dry dispersion method under an inert atmosphere.

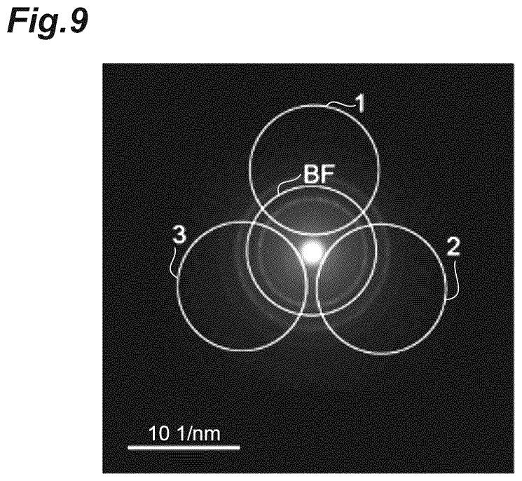

FIG. 9 shows an electron diffraction image of the sample of Example 5. A circle indicated by BF in the drawing is the observation position of a bright field image (not shown). Circles 1, 2 and 3 in FIG. 9 indicate the insertion positions (apertures) of the objective aperture. In FIG. 9, a plurality of bright spots are observed to be arrayed in a ring shape, and halo is observed, and it is thus found that crystal phases and an amorphous phase are present.

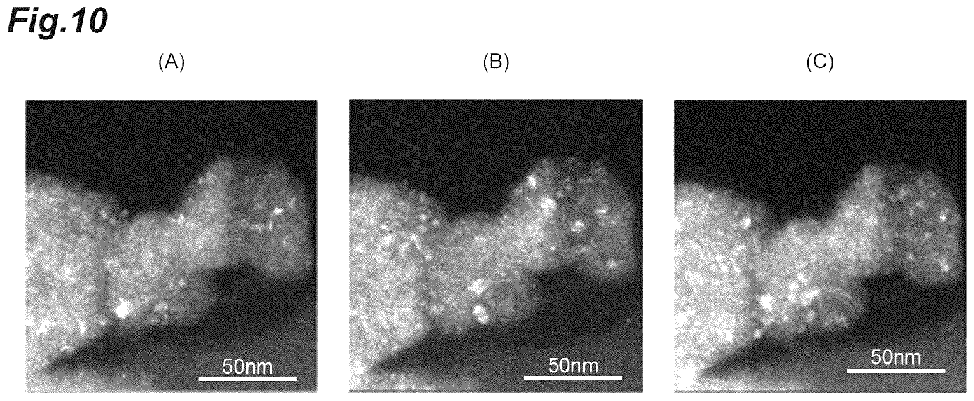

FIG. 10 is a view showing dark field observation images of the sample of Example 5 with the transmission electron microscope. (A), (B) and (C) in FIG. 10 correspond to dark field observation images measured by inserting the objective aperture into the positions 1, 2 and 3 in FIG. 9, respectively. In FIG. 10, white granular structures indicate crystal phases, and it is found that nanocrystals having a diameter of 2 to 8 nm are dispersed in the sample.

1. An alkali metal-containing oxide having a spinel structure and having a composition represented by the following formula (1),
wherein, in an X-ray diffraction chart measured regarding the alkali metal-containing oxide at 25° C. using a CuKα ray, a peak having a half width of 0.5° to 5° at 2θ is observed within a range of 40° to 45° at 2θ, 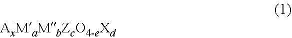
(in the formula (1), 1.1<x≤2.8, 0.8≤a<1.9, 0.05<b≤0.6, 1.0≤a+b<2.0, 0≤c<0.2, 0≤d<1.0, 0≤e<1.0,
A is an alkali metal element,
M′ is at least one element selected from the group consisting of Ti, Cr, Mn, Fe, Co, Ni and Cu,
M″ is at least one selected from the group consisting of Si, P, S, Ge and V,
Z is an element of Group II to Group XVI in a periodic table except oxygen, M′ and M″, and
X is a halogen element).

2. The alkali metal-containing oxide according to claim 1,
wherein, in a case where an electrochemical cell including an electrode containing the alkali metal-containing oxide, a lithium-metal auxiliary electrode and an electrolytic solution containing a lithium salt disposed between the electrode and the auxiliary electrode is produced, the electrochemical cell is charged up to 4.8 V based on Li/Li⁺, and discharging is then performed to 1.5 V, x in the formula (1) is within a range of 2.2 to 2.8.

3. The alkali metal-containing oxide according to claim 1,
wherein, in the formula (1), A includes Li.

4. The alkali metal-containing oxide according to claim 1,
wherein, in the formula (1), M″ includes V.

5. The alkali metal-containing oxide according to claim 1,
wherein, in the formula (1), 1.1<x≤2.0 is satisfied.

6. An electrode comprising:
the alkali metal-containing oxide according to claim 1.

7. A battery comprising:
the electrode according to claim 6 as a positive electrode; and
a negative electrode containing lithium.

8. A positive electrode active substance comprising:
a composite oxide containing an alkali metal element, an element M′ and an element M″,
wherein 8 to 15 mass % of the alkali metal element is contained, 32 to 57 mass % of the element M′, which is at least one selected from the group consisting of Ti, Cr, Mn, Fe, Co, Ni and Cu, is contained, and 3 to 30 mass % of the element M″, which is at least one selected from the group consisting of Si, P, S, Ge and V, is contained, in an X-ray diffraction chart measured regarding the positive electrode active substance at 25° C. using a CuKα ray, a peak pattern belonging to the spinel structure derived from the composite oxide is observed, and a peak having a half width of 0.5° to 5° is observed within a range of 40° to 45° at 2θ.

9. The alkali metal-containing oxide according to claim 1, having an amorphous phase.
